(19) United States
(12) Patent Application Publication
(10) Pub. No.: US 2006/0109264 A1
(43) Pub. Date: May 25, 2006

(54) Driving method of integrated circuit

(75) Inventors: Tadahiko Hirai, Tokyo (JP); Kikuzo Sawada, Tokyo (JP)

Correspondence Address: FITZPATRICK CELLA HARPER & SCINTO, 30 ROCKEFELLER PLAZA, NEW YORK, NY, 10112, US

(73) Assignee: CANNON KABUSHIKI KAISHA, Tokyo (JP)

(21) Appl. No.: 10/538,036

(22) PCT Filed: Mar. 25, 2004
(86) PCT No.: PCT/JP04/04189

§ 371 Date: Jun. 8, 2005

(30) Foreign Application Priority Data
Mar. 28, 2003 (JP) 2003-091787

(51) Int. Cl. G09G 5/00

(52) U.S. Cl. 345/204

(57) ABSTRACT

A field-effect transistor (T2SW) in a semiconductor integrated circuit is driven by periodically applying positive and negative voltage pulses, with reference to the voltage applied to the source and drain electrodes, to the gate electrode. Stable operation of integrated circuit is realized by a simple method, even if the integrated circuit includes a field-effect transistor exhibiting a readily fluctuating threshold voltage.

### TECHNICAL FIELD

The present invention relates to a method of driving an integrated circuit.

### BACKGROUND ART

Heretofore, integrated circuits made of a single-crystal silicon material are used in a variety of fields such as computers, communication and household appliances.

In recent years, on the other hand, the development of electronic devices and integrated circuits made of a material other than single-crystal silicon such as amorphous or polycrystalline silicon materials, organic semiconductors, diamond and silicon carbide has advanced rapidly. Those devices or circuits exhibit properties which single-crystal silicon based ones do not have. In such development, field-effect transistors (FETs) or thin-film transistors (TFTs) have been often studied as typical subject of investigation. While a transistor formed on a substrate such as glass is suitable for a low-temperature production process, it is sensitive to accumulation of impurities and defects at interfaces, which makes its operation tend to become unstable. In particular, thin-film transistors formed at low temperatures will contain a large number of defects at the interface between the gate insulating film and the semiconductor, and the threshold voltage tends to fluctuate. It has been often pointed out, for example, that amorphous silicon TFTs involve the problem that strong light irradiation or repeated voltage application thereto may expel hydrogen to generate defects and shift the threshold voltage. See for example, J. H. Wei et al., Journal of Applied Physics, Vol. 85 (1999), p. 543, or H. Hamada, Sharp Technical Report, No. 69 (1997), p. 75, etc.

### DISCLOSURE OF THE INVENTION

The present invention is to solve the conventional problem that the threshold voltage of a field-effect transistor tends to fluctuate, by driving an integrated circuit in a newly devised manner. In particular, it provides a method of stably driving a thin-film transistor formed at a low temperature and will therefore exhibit a readily fluctuating threshold voltage.

According to the invention, there is thus provided a method of driving an integrated circuit including a field-effect transistor, comprising periodically applying positive and negative voltages, with reference to the voltage applied to the source and drain electrodes, to the gate electrode of the field-effect transistor.

The above-mentioned field-effect transistor may preferably be a thin-film transistor. Since a thin-film transistor, particularly formed at a low temperature, may contain a number of defects at the interface between the gate insulating film and the semiconductor layer and its threshold voltage may readily fluctuate, the present invention is highly effective for stably driving such a transistor.

The above-mentioned field-effect transistor may preferably comprise a semiconductor material containing an organic substance. Since a transistor comprising a semiconductor material containing an organic substance may contain a larger number of defects, impurities, traps, etc. as compared with a single-crystal silicon semiconductor device and its threshold voltage may readily fluctuate, the present invention is also effective for stably driving such a transistor.

The above-mentioned field-effect transistor may also preferably comprise a semiconductor material containing amorphous silicon.

It is preferable to alternately apply positive and negative voltage pulses, with reference to the voltage applied to the source and drain electrodes, to the gate electrode of the above-mentioned field-effect transistor.

It is also preferable to continuously applying positive (or negative) voltage pulses, with reference to the voltage applied to the source and drain electrodes, to the gate electrode of the above-mentioned field-effect transistor, and then applying one or more negative (or positive) voltage pulses.

It is possible to stably drive an integrated circuit including a transistor exhibiting an unstable threshold voltage by using the driving method of the present invention.

Further, it is also possible to realize stable operation of an IC card including such a transistor by using the above-mentioned driving method.

According to the present invention, even if the threshold voltage of a field-effect transistor included in an integrated circuit readily fluctuates, it is possible to realize stable operation of the integrated circuit including the transistor by a simple method. This advantageous effect is remarkable particularly in an integrated circuit including an organic transistor.

In addition, it is possible to realize an IC card with high operation stability.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic diagram showing the concept of a circuit where a method of the present invention is implemented;

FIG. 2 is a chart showing the operation method of the circuit of FIG. 1;

FIG. 3 is a circuit diagram showing a first embodiment;

FIG. 4 is a chart showing the operation method of the circuit of FIG. 3;

FIG. 5A is a graph showing the characteristics of the transistor of the first embodiment;

FIG. 5B is a graph showing the characteristics of the transistor of the first embodiment;

FIG. 6 is a circuit diagram showing a second embodiment;

FIG. 7 is a chart showing the operation method of the circuit of FIG. 6;

FIG. 8 is a diagram of a circuit for driving a light emitting diode according to the method of the present invention;

FIG. 9 is a chart showing the operation method of the circuit of FIG. 8;

FIG. 10 is a diagram of a circuit for driving a liquid crystal cell according to the method of the present invention; and

FIG. 11 is a chart showing the operation method of the circuit of FIG. 10.

### BEST MODE FOR CARRYING OUT THE INVENTION

Preferred embodiments of the present invention will now be described in detail in accordance with the accompanying drawings.

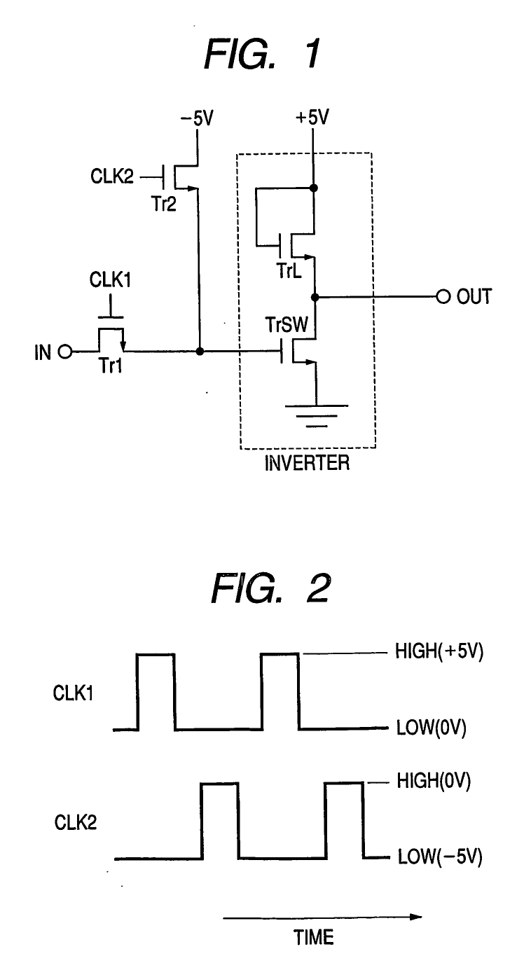

Circuits and operation methods shown in FIGS. 1 and 2 will be explained firstly.

FIG. 1 shows an embodiment where the above-mentioned driving method is applied to an inverter which is one of the basic circuits used for an integrated circuit. In this embodiment, each transistor is an n-channel TFT (n-TFT), and the n-TFT comes to the ON state when a positive voltage relative to the source and drain voltage is applied to the gate. In this embodiment, it comes to the ON state at a gate voltage of +5V.

The inverter is constituted by a load transistor (TrL) and a switching transistor (TrSW), and outputs the reverse voltage with reference to the input voltage (for example, it outputs ‘Low’ (=0V) when the input is ‘High’ (=+5V). In addition, for driving the inverter, the input signal is controlled by using Tr1 and Tr2. Tr1 controls the input timing to the inverter, while Tr2 controls the timing of applying a voltage of −5V to the gate electrode of TrSW.

For example, control signals CLK1 and CLK2 as shown in FIG. 2 are inputted into Tr1 and Tr2. Either ‘High’ (+5V) or ‘Low’ (0V) is applied to the IN terminal in FIG. 1 as an IN signal, and the IN signal is inputted into the gate electrode of TrSW when CLK1 =+5V (‘High’ state).

On the other hand, although a voltage of −5V is applied to the gate electrode of TrSW when CLK2 =+5V (‘High’ state), the control signal differs in phase from that applied to CLK1, and hence, −5V and the IN signal (+5V) are applied to the gate electrode of TrSW alternately. By this method, +5V and −5V are applied substantially alternately to the gate electrode of TrSW, and hence, it is possible to prevent fluctuation of the threshold voltage. It is also possible to make the ‘High’ state duration of CLK2 to be a half of that of CLK1 so that the application of +5V (IN signal) and −5V may be equally weighted.

The present invention will be specifically explained below with citing embodiments.

### EMBODIMENT 1

A first embodiment of the present invention will be explained.

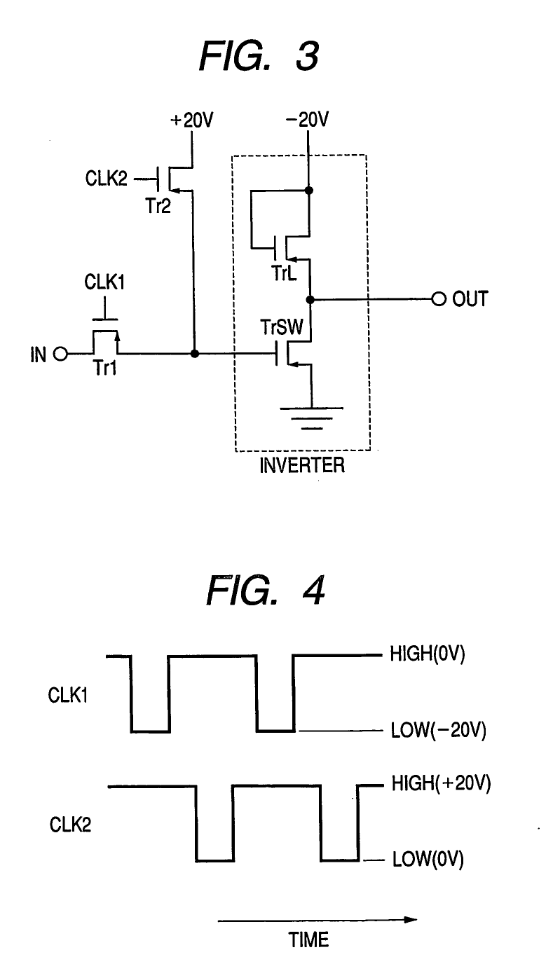

An inverter as shown in FIG. 3 was prototyped by using organic TFTs with pentacene as main component. This organic TFT shows the characteristics of p channel type (p-TFT), and since the thickness of the gate insulating film is large relative to a Si-based device, a drive voltage is set to −20V.

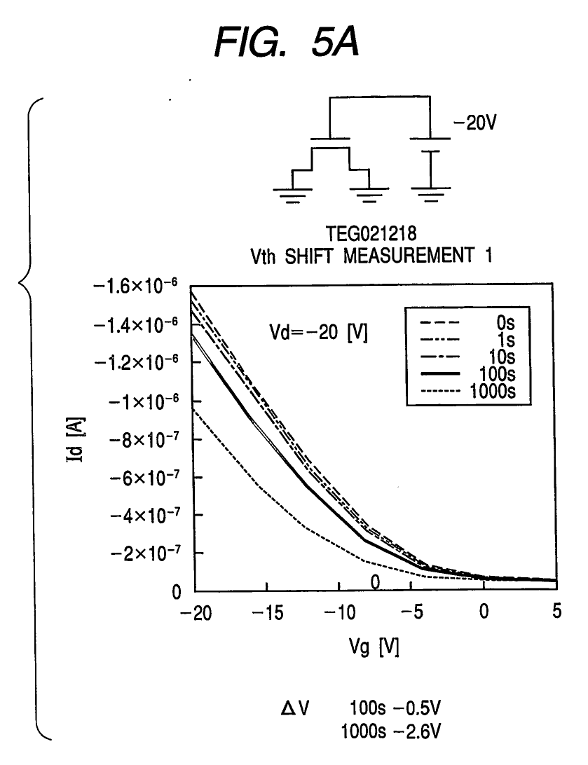

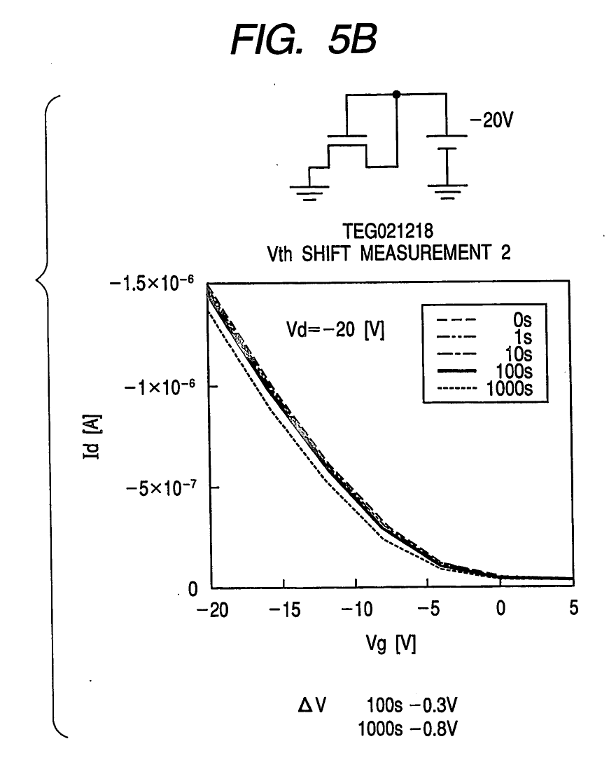

First, a discrete organic TFT was examined. By making Vd (drain voltage) equal to −20V, and changing Vg (gate voltage) between 0 and −20V, the Vg dependability of Id (drain current) was investigated. At this time, voltage stress was given beforehand to the gate electrode, or between the gate electrode and the drain electrode. As a result, it was observed that the threshold voltage (Vth) shifted to the minus side depending on the application time of the voltage stress. However, a large shift was observed when the stress voltage was applied only to the gate electrode (FIG. 5A), while it was ignorable when the voltage stress (−20V) was applied to the gate electrode and the drain electrode (FIG. 5B). In addition, when reverse voltage stress (+20V) was applied to the TFT exhibiting a shifted threshold, the threshold was restored to its original level.

From this result, it is known that, although the threshold shift of the load transistor (TrL) in FIG. 3 is of an ignorable level, the threshold voltage shift is significant when the input signal is continuously applied to the switching transistor (TrSW).

The inverter shown in FIG. 3 was driven by applying the CLK1 and CLK2 signals as shown in FIG. 4 so that the Vth of TrSW would not shift. As a result, it was confirmed that the inverter operated stably.

### EMBODIMENT 2

A second embodiment of the present invention will be explained.

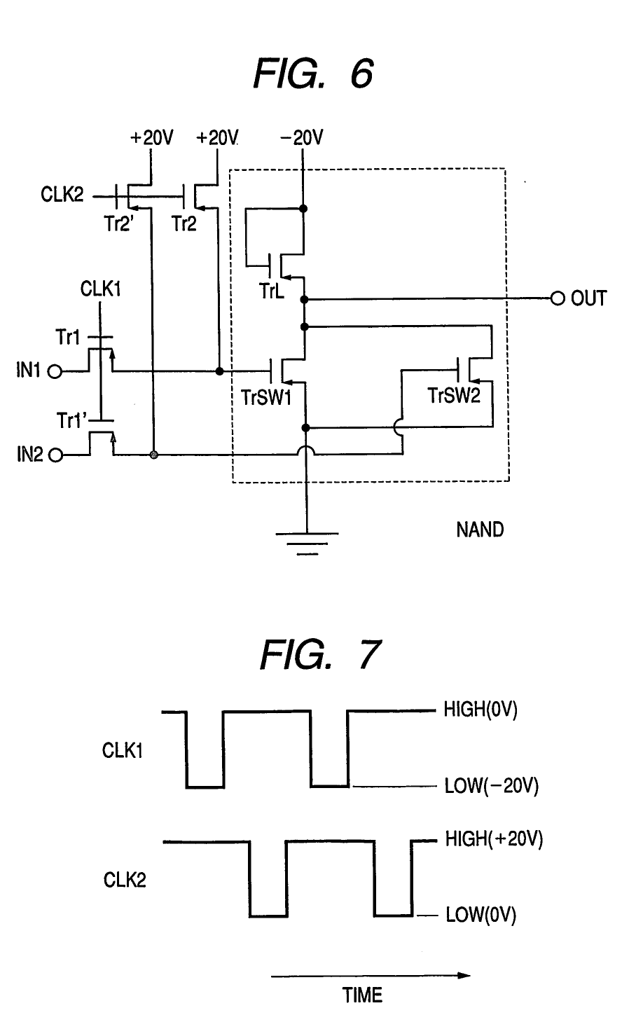

FIG. 6 is an example of forming a NAND logical circuit by using the same p-TFTs as the first embodiment.

It was found that the NAND logical circuit operated stably by applying the CLK1 and CLK2 signals as shown in FIG. 7.

### OTHER EMBODIMENTS

It is possible to drive a light emitting diode or a liquid crystal cell by using the driving method of the integrated circuit in the present invention. From the above-described embodiments, it would be self-evident for those skilled in the art that it is applicable to driving operation of various apparatus such as a light emitting diode device and a liquid crystal display device.

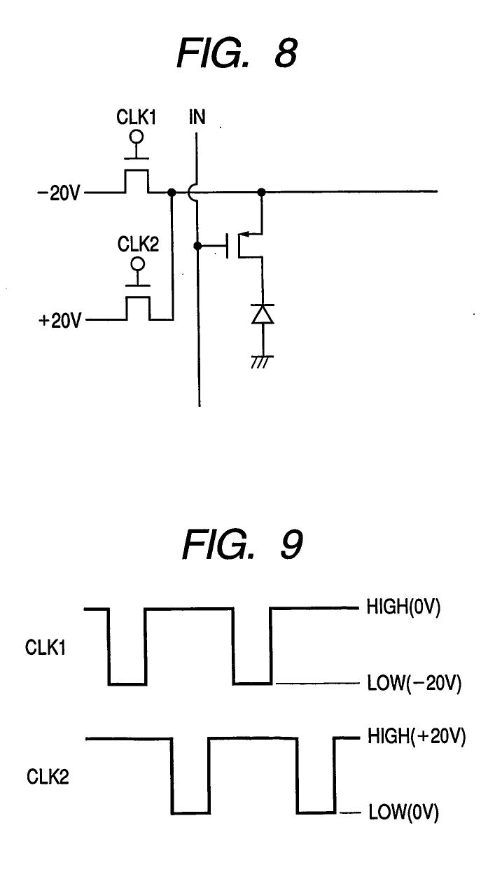

For example, a preferred embodiment of the driving method of a light emitting diode is shown in FIGS. 8 and 9. FIG. 8 is a circuit diagram and reference symbols are the same as those of the above-described embodiments except for the diode. FIG. 9 is a chart showing a driving method of the circuit similarly to FIG. 2.

More detailed information including specific apparatus structure is provided by, for example, Japanese Patent Application Laid-Open No. H5-94150, and it is hence easy for those in the art to implement the present invention, even without further description.

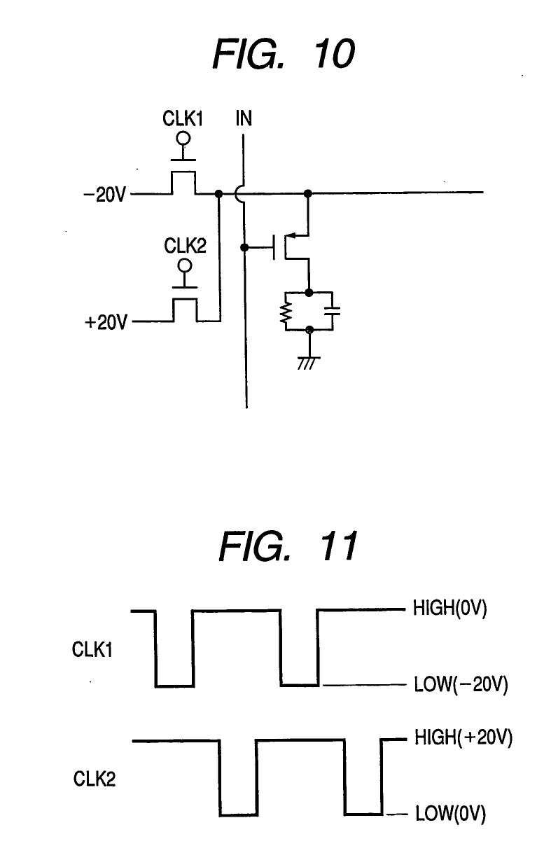

In addition, for example, an example of the driving method of a liquid crystal cell is shown in FIGS. 10 and 11. FIG. 10 is a circuit diagram and the components are the same as the above-described embodiments except the resistor and the capacitor for driving liquid crystal. FIG. 11 is a chart similar to FIG. 2, showing a driving method of the circuit.

More detailed information including specific apparatus structure is provided by, for example, Japanese Patent Application Laid-Open No. H7-13518, and it is hence easy for those in the art to implement the present invention, even without further description.

Thus, the preferred embodiments of the method of driving an integrated circuit of the present invention are summarized as follows.

In the first embodiment, the field-effect transistor is a thin-film transistor.

In the second embodiment, the field-effect transistor comprises a semiconductor material containing an organic substance.

In the third embodiment, the field-effect transistor comprises a semiconductor material containing amorphous silicon.

In the fourth embodiment, positive and negative voltage pulses, with reference to the voltage applied to the source and the drain electrodes, are applied alternately to the gate electrode of the field-effect transistor.

In the fifth embodiment, positive (or negative) voltage pulses, with reference to the voltage applied to the source and the drain electrodes, are applied to the gate electrode of the field-effect transistor, and then one or more negative (or positive) voltage pulses are applied.

In the sixth embodiment, the application of positive and negative voltage is equivalently weighted by adjusting the duration or pulse number of the positive and negative voltages applied.

The seventh embodiment is an integrated circuit to be driven by using the above-described method.

The eighth embodiment is an IC card to be driven by using the above-described method.

The ninth embodiment is a light emitting diode device to be driven by using the above-described method.

The tenth embodiment is a liquid crystal device to be driven by using the above-described method.

The present invention is not limited to the above embodiments and various changes and modifications can be made within the spirit and scope of the present invention. Therefore to apprise the public of the scope of the present invention, the following claims are made.

1. A method of driving an integrated circuit including a field-effect transistor, comprising periodically applying positive and negative voltages, with reference to the voltage applied to the source and drain electrodes, to the gate electrode of the field-effect transistor.

2. The method according to claim 1, wherein the field-effect transistor is a thin-film transistor.

3. The method according to claim 1, wherein the field-effect transistor comprises a semiconductor material containing an organic substance.

4. The method according to claim 1, wherein the field-effect transistor comprises a semiconductor material containing amorphous silicon.

5. The method according to claim 1, wherein positive and negative voltage pulses, with reference to the voltage applied to the source and drain electrodes, are applied alternately to the gate electrode of the field-effect transistor.

6. The method according to claim 1, wherein positive or negative voltage pulses, with reference to the voltage applied to the source and drain electrodes, are continuously applied to the gate electrode of the field-effect transistor, and then one or more negative or positive voltage pulses respectively are applied to the gate electrode.

7. The method according to claim 1, wherein the application of positive and negative voltage pulses is equivalently weighted by adjusting the duration or pulse number of the positive and negative voltage pulses applied.

8. An integrated circuit to be driven by using the method according to claim 1.

9. An IC card to be driven by using the method according to claim 1.

10. A light emitting diode device to be driven by using the method according to claim 1.

11. A liquid crystal device to be driven by using the method according to claim 1.
